(19) United States
(12) Patent Application Publication
(10) Pub. No.: US 2023/0142305 A1
(43) Pub. Date: May 11, 2023

(54) ROAD CONDITION DETECTION SYSTEMS AND METHODS

(71) Applicant: GM GLOBAL TECHNOLOGY OPERATIONS LLC, Detroit, MI (US)

(72) Inventors: Qingrong ZHAO, Madison Heights, MI (US); Bakhtiar B. LITKOUHI, Washington, MI (US)

(21) Appl. No.: 17/519,705

(22) Filed: Nov. 5, 2021

(51) Int. Cl. G06K 9/00; G06K 9/62; G06T 7/30; G06K 9/20

(52) U.S. Cl. CPC G06K 9/00791; G06K 9/6232; G06T 7/30; G06K 9/2054; G06K 9/629; G06T 2207/10028; G06T 2207/10132; G06T 2207/30252; G06T 2207/20221

(57) ABSTRACT

In a feature, a road condition detection system includes: a combination module configured to generate a combined image based on at least two images, each of the two images including a road and generated based on one of: (a) an image captured using a camera, (b) light detection and ranging (LIDAR) data, (c) radar data, and (d) ultrasonic data; a feature extraction module configured to generate a first feature map based on the combined image; an information map module configured to generate a second feature map based on at least one operating parameter; a joining module configured to generate a joint feature map based on the first and second feature maps; and a condition module configured to set a road condition of the road in front of a vehicle based on the joint feature map.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle sensors and cameras and more particularly to systems and methods for detecting road condition.

Vehicles include one or more torque producing devices, such as an internal combustion engine and/or an electric motor. A passenger of a vehicle rides within a passenger cabin (or passenger compartment) of the vehicle.

Vehicles may include one or more different type of sensors that sense vehicle surroundings. One example of a sensor that senses vehicle surroundings is a camera configured to capture images of the vehicle surroundings. Examples of such cameras include forward-facing cameras, rear-facing cameras, and side facing cameras. Another example of a sensor that senses vehicle surroundings includes a radar sensor configured to capture information regarding vehicle surroundings. Other examples of sensors that sense vehicle surroundings include sonar sensors and light detection and ranging (LIDAR) sensors configured to capture information regarding vehicle surroundings.

### SUMMARY

In a feature, a road condition detection system includes: a combination module configured to generate a combined image based on at least: a first image including a road in front of the vehicle generated based on one of: (a) an image captured using a camera of the vehicle, (b) light detection and ranging (LIDAR) data regarding the road in front of the vehicle, (c) radar data regarding the road in front of the vehicle, (d) ultrasonic data regarding the road in front of the vehicle; and a second image generated based on one of: (a) an image captured using a camera of the vehicle, (b) light detection and ranging (LIDAR) data regarding the road in front of the vehicle, (c) radar data regarding the road in front of the vehicle, (d) ultrasonic data regarding the road in front of the vehicle; a feature extraction module configured to generate a first feature map based on the combined image; an information map module configured to generate a second feature map based on at least one of: an ambient temperature; a windshield wiper state; an antilock braking system (ABS) state; a traction control system (TCS) state; weather at the vehicle; a wheel slip; an acceleration of the vehicle; a stability control system state; and road condition information received from at least one of a second vehicle and infrastructure; a joining module configured to generate a joint feature map based on the first and second feature maps; and a condition module configured to set a road condition of the road in front of the vehicle based on the joint feature map.

In further features, the feature extraction module includes one of a neural network and an image processor module configured to generate the first feature map based on the combined image.

In further features, the neural network is a convolutional neural network.

In further features, the combination image is configured to generate the combined image by at least one of (a) aligning edges of the first and second images, (b) concatenating the first and second images on a single plane, and (c) superimposing the first and second images.

In further features, the joining module is configured to generate the joint feature map by concatenating the first and second feature maps.

In further features, image generation module is configured to: receive a third image including the road in front of the vehicle captured using the camera; determine a region of interest (ROI) including the road in front of the vehicle in the third image; and crop the third image to the ROI to generate the first image.

In further features, an image generation module is configured to: receive the LIDAR data regarding the road in front of the vehicle from a LIDAR sensor of the vehicle; transform the LIDAR data into a third image; determine a region of interest (ROI) including the road in front of the vehicle in the third image; and crop the third image to the ROI to generate the first image.

In further features, an image generation module is configured to: receive the radar data regarding the road in front of the vehicle from a radar sensor of the vehicle; transform the radar data into a third image; determine a region of interest (ROI) including the road in front of the vehicle in the third image; and crop the third image to the ROI to generate the first image.

In further features: the combination module is configured to generate the combined image based on: (a) the first image including a road in front of the vehicle generated based on a fourth image captured using a camera of the vehicle, (b) the second image generated based on light detection and ranging (LIDAR) data regarding the road in front of the vehicle, and (c) a third image generated based on radar data regarding the road in front of the vehicle; the road condition detection system further includes an image generation module configured to: receive a fourth image including the road in front of the vehicle captured using the camera; determine a region of interest (ROI) including the road in front of the vehicle in the fourth image; crop the fourth image to the ROI to generate the first image; receive the LIDAR data regarding the road in front of the vehicle from a LIDAR sensor of the vehicle; transform the LIDAR data into a fifth image; determine a region of interest (ROI) including the road in front of the vehicle in the fifth image; crop the fifth image to the ROI to generate the second image; receive the radar data regarding the road in front of the vehicle from a radar sensor of the vehicle; transform the radar data into a sixth image; determine a region of interest (ROI) including the road in front of the vehicle in the sixth image; and crop the sixth image to the ROI to generate the third image.

In further features, the condition module includes one of a neural network configured to determine the road condition based on the joint feature map and a support vector machine configured to determine the road condition based on the joint feature map.

In further features, the condition module includes the neural network, and the neural network is a fully connected convolutional neural network.

In further features, the information map module is configured to generate the second feature map based on at least two of: the ambient temperature; the windshield wiper state; the ABS state; the TCS state; the weather at the vehicle; the wheel slip; the acceleration of the vehicle; the stability control system state; and the road condition information received from at least one of the second vehicle and infrastructure.

In further features, an engine control module is configured to selectively adjust torque output of an engine of the vehicle based on the road condition.

In further features, a steering control module is configured to selectively adjust steering of the vehicle based on the road condition.

In further features, a braking control module is configured to selectively adjust brakes of the vehicle based on the road condition.

In further features, a transmission control module is configured to selectively adjust at least one parameter of a transmission based on the road condition.

In further features, an inverter module is configured to selectively adjust power applied to an electric motor of the vehicle based on the road condition.

In further features, a module is configured to, based on the road condition, output at least one of (a) a visual alert and (b) an audible alert.

In a feature, a road condition detection system of a vehicle includes: a combination module configured to generate a combined image based on at least two of: a first image including a road in front of the vehicle captured using a camera of the vehicle; a second image generated based on light detection and ranging (LIDAR) data regarding the road in front of the vehicle; and a third image generated based on radar data regarding the road in front of the vehicle; a feature extraction module configured to generate a first feature map based on the combined image; an information map module configured to generate a second feature map based on at least one of: an ambient temperature; a windshield wiper state; an antilock braking system (ABS) state; a traction control system (TCS) state; weather at the vehicle; a wheel slip; an acceleration of the vehicle; a stability control system state; and road condition information received from at least one of a second vehicle and infrastructure; a joining module configured to generate a joint feature map based on the first and second feature maps; and a condition module configured to set a road condition of the road in front of the vehicle based on the joint feature map.

In a feature, a road condition detection method includes: generating a combined image based on at least: a first image including a road in front of the vehicle generated based on one of: (a) an image captured using a camera of the vehicle, (b) light detection and ranging (LIDAR) data regarding the road in front of the vehicle, (c) radar data regarding the road in front of the vehicle, (d) ultrasonic data regarding the road in front of the vehicle; and a second image generated based on one of: (a) an image captured using a camera of the vehicle, (b) light detection and ranging (LIDAR) data regarding the road in front of the vehicle, (c) radar data regarding the road in front of the vehicle, (d) ultrasonic data regarding the road in front of the vehicle; generating a first feature map based on the combined image; generating a second feature map based on at least one of: an ambient temperature; a windshield wiper state; an antilock braking system (ABS) state; a traction control system (TCS) state; weather at the vehicle; a wheel slip; an acceleration of the vehicle; a stability control system state; and road condition information received from at least one of a second vehicle and infrastructure; generating a joint feature map based on the first and second feature maps; and setting a road condition of the road in front of the vehicle based on the joint feature map.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of a vehicle including various external cameras and sensors;

FIG. 3 is a functional block diagram of an example implementation of a road condition module;

FIG. 4 is a functional block diagram of an example implementation of an image generation module;

FIG. 5 includes an illustration of an example of a combined image;

FIG. 6 is a functional block diagram of an example implementation of the information map module;

FIG. 7 is example mapping of temperature values to category values for ambient temperature;

FIG. 8 is an example mapping of category values to pixel values for the ambient temperature;

FIG. 9 is an example illustration of a feature sheet generated for the ambient temperature;

FIG. 10 is an example illustration of joining feature maps; and

FIG. 11 is a flowchart depicting an example method of determining a condition of a road in front of a vehicle.

In the drawings, reference numbers may be reused to identify similar and/or identical elements.

### DETAILED DESCRIPTION

A vehicle may include a camera configured to capture images within a predetermined field of view (FOV) around an exterior of the vehicle. A perception module may perceive objects around the vehicle and determine locations of the objects.

For example, a camera may be used to capture images including a road in front of the vehicle, and a road condition module can determine a condition of the road based on the images. Alternatively, the road condition module can determine the condition of the road based on input from a light detection and ranging (LIDAR) sensor. Alternatively, the road condition module can determine the condition of the road based on input from a radar sensor.

The road condition module may determine the condition of the road differently, however, based on the input used. For example, for a dry salt covered road, the road condition module may determine that the road is snow covered using images from a camera and determine that the road is dry using input from a LIDAR sensor.

The present application involves a road condition module configured to determine a road condition (e.g., dry, wet, snow covered, icy, etc.) by fusing together multiple different types of input, such as images from one or more cameras, LIDAR data from one or more LIDAR sensors, data from one or more radar sensors, temperature inputs, a state of windshield wipers, a status of an antilock braking system (ABS), a traction control system (TCS) state, weather data, acceleration of a vehicle, ambient air temperature, ambient humidity, etc. This provides an efficient and sophisticated synthesis of different types of input and provides for reliable, robust, and accurate road condition detection.

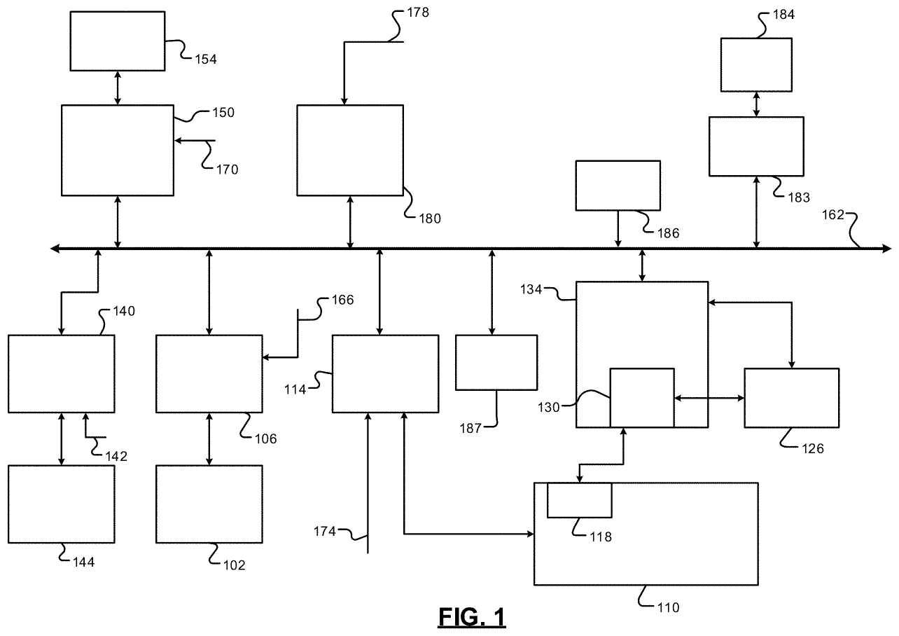

Referring now to FIG. 1, a functional block diagram of an example vehicle system is presented. While a vehicle system for a hybrid vehicle is shown and will be described, the present application is also applicable to non-hybrid vehicles, electric vehicles, fuel cell vehicles, and other types of vehicles. The present application is applicable to autonomous vehicles, semi-autonomous vehicles, non-autonomous vehicles, shared vehicles, non-shared vehicles, and other types of vehicles.

An engine 102 may combust an air/fuel mixture to generate drive torque. An engine control module (ECM) 106 controls the engine 102. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter module (PIM) 134 may control the electric motor 118 and the PCD 130. The PCD 130 applies power from the battery 126 to the electric motor 118 based on signals from the PIM 134, and the PCD 130 provides power output by the electric motor 118, for example, to the battery 126. The PIM 134 may include, for example, an inverter.

A steering control module 140 controls steering/turning of wheels of the vehicle, for example, based on driver turning of a steering wheel within the vehicle and/or steering commands from one or more vehicle control modules. A steering wheel angle (SWA) sensor (not shown) monitors rotational position of the steering wheel and generates a SWA 142 based on the position of the steering wheel. As an example, the steering control module 140 may control vehicle steering via an electronic power steering (EPS) motor 144 based on the SWA 142. However, the vehicle may include another type of steering system. A brake control module 150 may selectively control (e.g., friction) brakes 154 of the vehicle based on one or more driver inputs, such as a brake pedal position (BPP) 170.

Modules of the vehicle may share parameters via a network 162, such as a controller area network (CAN). A CAN may also be referred to as a car area network. For example, the network 162 may include one or more data buses. Various parameters may be made available by a given module to other modules via the network 162.

The driver inputs may include, for example, an accelerator pedal position (APP) 166 which may be provided to the ECM 106. The BPP 170 may be provided to the brake control module 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

An infotainment module 183 may output various information via one or more output devices 184. The output devices 184 may include, for example, one or more displays (non-touch screen and/or touch screen), one or more sets of virtual reality (VR) goggles, one or more sets of augmented reality (AR) goggles, one or more other suitable types of video output devices, one or more speakers, one or more haptic devices, and/or one or more other suitable types of output devices. In various implementations, goggles may include one or more video devices and one or more speakers.

The infotainment module 183 may output video via the one or more displays, one or more sets of VR goggles, and/or one or more sets of AR goggles. The infotainment module 183 may output audio via the one or more speakers. The infotainment module 183 may output other feedback via one or more haptic devices. For example, haptic devices may be included with one or more seats, in one or more seat belts, in the steering wheel, etc. Examples of displays may include, for example, one or more displays (e.g., on a front console) of the vehicle, a head up display (HUD) that displays information via a substrate (e.g., windshield), one or more displays that drop downwardly or extend upwardly to form panoramic views, and/or one or more other suitable displays.

The vehicle may include a plurality of external sensors and cameras, generally illustrated in FIG. 1 by 186. One or more actions may be taken based on input from the external sensors and cameras 186. For example, the infotainment module 183 may display video, various views, and/or alerts on a display via input from the external sensors and cameras 186 during driving.

As another example, based on input from the external sensors and cameras 186, a road condition module 187 determines a condition of the road (a road condition) in front of the vehicle. The road condition may include, for example, dry, wet, snow covered, ice covered, or another suitable road condition.

One or more modules may take one or more actions based on the road condition. For example, the ECM 106 may adjust torque output of the engine 102 based on the road condition. Additionally or alternatively, the PIM 134 may control power flow to and/or from the electric motor 118 based on the road condition. Additionally or alternatively, the brake control module 150 may adjust braking based on the road condition. Additionally or alternatively, the steering control module 140 may adjust steering based on the road condition. For example, one or more actions may be taken to maximize wheel traction and minimize wheel slip for the road condition.

The vehicle may include one or more additional control modules that are not shown, such as a chassis control module, a battery pack control module, etc. The vehicle may omit one or more of the control modules shown and discussed.

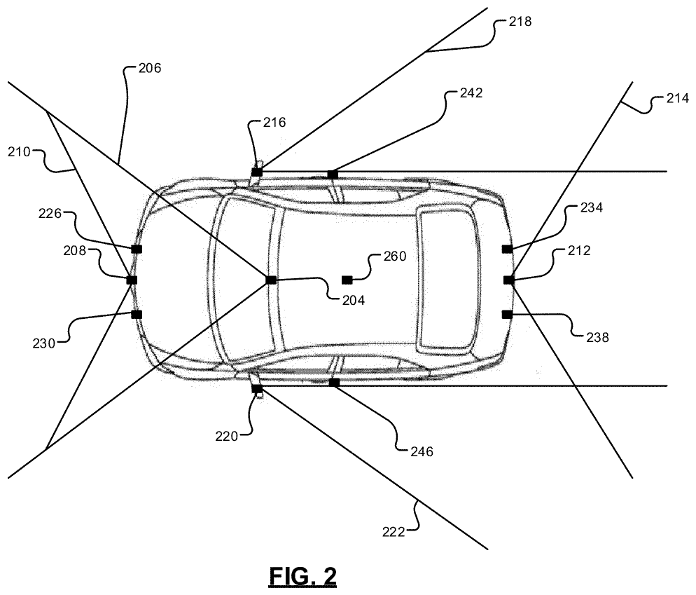

Referring now to FIG. 2, a functional block diagram of a vehicle including examples of external sensors and cameras is presented. The external sensors and cameras 186 (FIG. 1) include various cameras positioned to capture images and video outside of (external to) the vehicle and various types of sensors measuring parameters outside of (external to) the vehicle. Examples of the external sensors and cameras 186 will now be discussed. For example, a forward-facing camera 204 captures images and video of images within a predetermined field of view (FOV) 206 in front of the vehicle.

A front camera 208 may also capture images and video within a predetermined FOV 210 in front of the vehicle. The front camera 208 may capture images and video within a predetermined distance of the front of the vehicle and may be located at the front of the vehicle (e.g., in a front fascia, grille, or bumper). The forward-facing camera 204 may be located more rearward, however, such as with a rear-view mirror at a windshield of the vehicle. The forward-facing camera 204 may not be able to capture images and video of items within all of or at least a portion of the predetermined FOV of the front camera 208 and may capture images and video more than the predetermined distance of the front of the vehicle. In various implementations, only one of the forward-facing camera 204 and the front camera 208 may be included.

A rear camera 212 captures images and video within a predetermined FOV 214 behind the vehicle. The rear camera 212 may be located at the rear of the vehicle, such as near a rear license plate.

A right camera 216 captures images and video within a predetermined FOV 218 to the right of the vehicle. The right camera 216 may capture images and video within a predetermined distance to the right of the vehicle and may be located, for example, under a right side rear-view mirror. In various implementations, the right side rear-view mirror may be omitted, and the right camera 216 may be located near where the right side rear-view mirror would normally be located.

A left camera 220 captures images and video within a predetermined FOV 222 to the left of the vehicle. The left camera 220 may capture images and video within a predetermined distance to the left of the vehicle and may be located, for example, under a left side rear-view mirror. In various implementations, the left side rear-view mirror may be omitted, and the left camera 220 may be located near where the left side rear-Rview mirror would normally be located. While the example FOVs are shown for illustrative purposes, the present application is also applicable to other FOVs. In various implementations, FOVs may overlap, for example, for more accurate and/or inclusive stitching.

The external sensors and cameras 186 may additionally or alternatively include various other types of sensors, such as light detection and ranging (LIDAR) sensors, ultrasonic sensors, radar sensors, and/or one or more other types of sensors. For example, the vehicle may include one or more forward-facing ultrasonic sensors, such as forward-facing ultrasonic sensors 226 and 230, one or more rearward facing ultrasonic sensors, such as rearward facing ultrasonic sensors 234 and 238. The vehicle may also include one or more right side ultrasonic sensors, such as right side ultrasonic sensor 242, and one or more left side ultrasonic sensors, such as left side ultrasonic sensor 246. The vehicle may also include one or more light detection and ranging (LIDAR) sensors, such as LIDAR sensor 260. The locations of the cameras and sensors are provided as examples only and different locations could be used. Ultrasonic sensors output ultrasonic signals around the vehicle.

The external sensors and cameras 186 may additionally or alternatively include one or more other types of sensors, such as one or more sonar sensors, one or more radar sensors, and/or one or more other types of sensors.

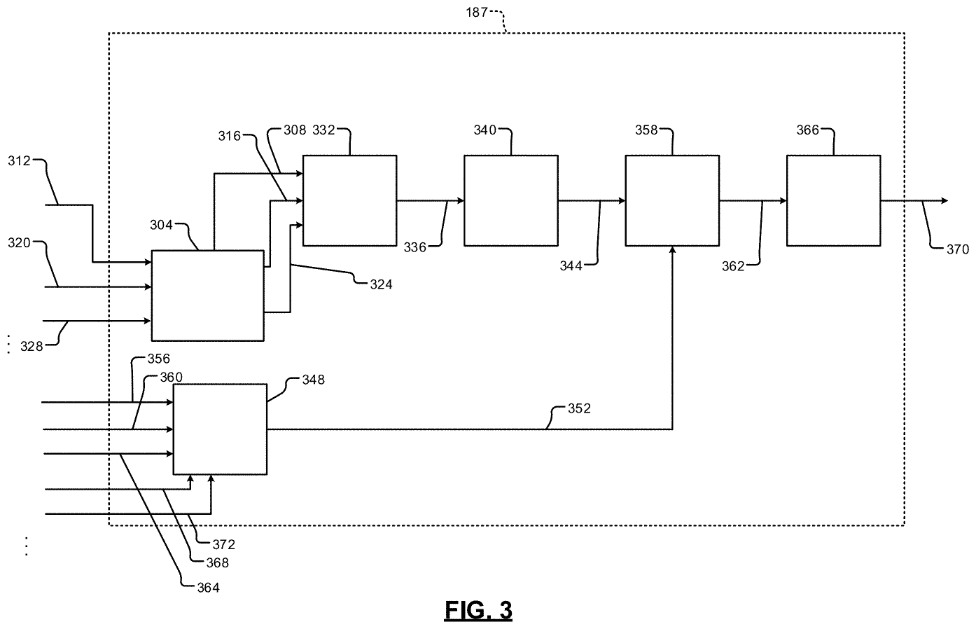

FIG. 3 is a functional block diagram of an example implementation of the road condition module 187. An image generation module 304 receives input from the external cameras and sensors 186 and generates images based on the input, respectively. For example, the image generation module 304 generates a camera image 308 including a portion of the road in front of the vehicle based on an image 312 from a forward-facing camera (e.g., 204). The image generation module 304 generates a LIDAR image 316 including a portion of the road in front of the vehicle based on LIDAR data 320 from in front of the vehicle from the LIDAR sensor 260. The image generation module 304 generates a radar image 324 including a portion of the road in front of the vehicle based on radar data 328 from in front of the vehicle from the one or more radar sensors. The image generation module 304 may also generate one or more other images based on input from one or more other external cameras and/or sensors configured to capture data including the road in front of the vehicle.

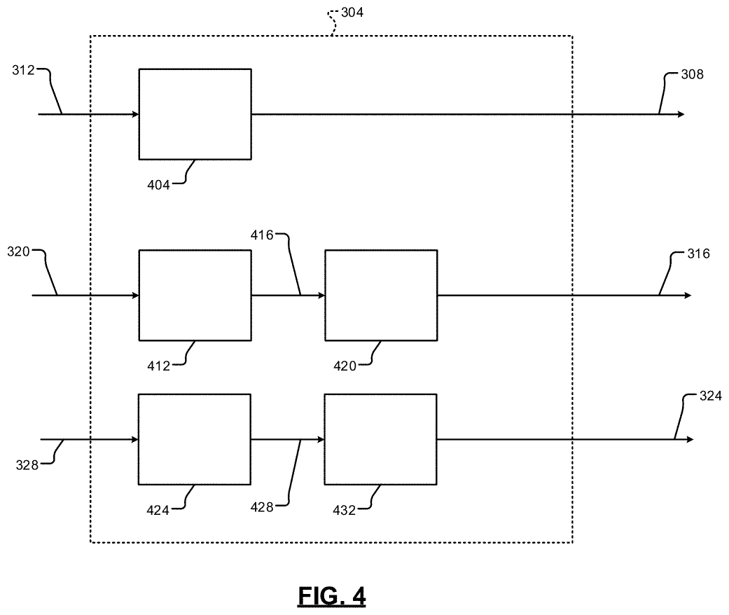

FIG. 4 includes a functional block diagram of an example implementation of the image generation module 304. A region of interest (ROI) module 404 determines an ROI including the road in front of the vehicle in the image 312 and crops the image 312 to the ROI to generate the camera image 308.

A transform module 412 transforms the LIDAR data 320 from the LIDAR sensor 260 into an initial image 416, such as using a LIDAR to image transformation algorithm. An ROI module 420 determines an ROI including the road of the vehicle in the initial image 416 and crops the initial image 416 to the ROI to generate the LIDAR image 316.

A transform module 424 transforms the radar data 328 from the one or more radar sensors into an initial image 428, such as using a radar to image transformation algorithm. An ROI module 432 determines an ROI including the road of the vehicle in the initial image 428 and crops the initial image 428 to the ROI to generate the radar image 324.

The image generation module may include one or more transform module that transform other types of camera and/or sensor input into initial images and crop the initial images into ROIs including images of portions of the road in front of the vehicle.

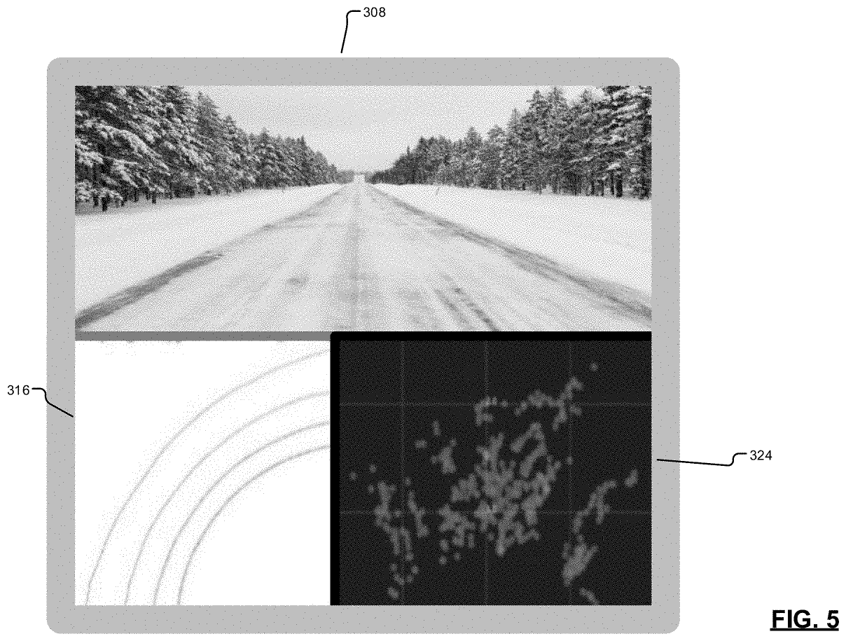

Referring back to FIG. 3, a combination module 332 generates a combined image 336 by combining the camera image 308, the LIDAR image 316, and the radar image 324. For example, the combination module 332 may join a bottom edge of the camera image 308 with top edges of the LIDAR and radar images 316 and 324. The combination module 332 may vertically align a left edge of the camera image 308 with a left edge of the LIDAR image 316. The combination module 332 may vertically align a right edge of the camera image 308 with a right edge of the radar image 324. FIG. 5 includes an illustration of an example of the combined image 336 at a given time. In various implementations, the combination module 332 may additionally or alternatively concatenate the images on a single plane and/or superimpose the images.

Referring back to FIG. 3, a feature extraction module 340 generates a sensor feature map 344 by performing feature extraction on the combined image 336. The sensor feature map 344 includes a stack of matrices. The feature extraction module 340 may include, for example, a convolutional neural network (CNN) or an image processing module that performs the feature extraction. While the example of a CNN is provided, the present application is also applicable to other types of neural networks and machine learning configured to perform feature extraction.

The road condition module 187 also includes an information map module 348 that generates an information feature map 352 based on data (including multiple different types of information) regarding road condition other than input from the external cameras and sensors 186. Like the sensor feature map 344, the information feature map 352 includes a stack of matrices regarding features of the data. Examples of the data regarding road condition include ambient air temperature 356, windshield wiper state (e.g., on or off) 360, antilock braking system (ABS) state (e.g., on or off) 364, traction control system (TCS) state (e.g., on or off) 368, weather data 372, and other data that can be used to determine a road condition. Other examples of data regarding road condition include wheel slip, vehicle acceleration (lateral and/or longitudinal), stability control system state (e.g., on or off), and information regarding road condition obtained from another vehicle (e.g., via vehicle to vehicle communication) and/or from instrastructure (e.g., via vehicle to infrastructure communication). The data is used collectively (along with the input from the external sensors and cameras 186) to more accurately make the road condition determination.

The ambient air temperature 356 may be measured using a temperature sensor of the vehicle or obtained in another manner, such as with the weather data 372. The weather data 372 may be received via a remote weather source via a network, such as a cellular network, a satellite network, a wireless communication network, another suitable type of network, a mobile device that is connected to the vehicle, or in another suitable manner. The ambient humidity may be measured using a humidity sensor of the vehicle or obtained in another manner, such as with the weather data 372. The ABS state 364 and the TCS state 368 may be obtained, for example, from the braking control module 150 and the BCM 180, respectively, or from other suitable modules of the vehicle.

As an example, the TCS state 368 indicates that wheel slip is occurring, which may more commonly occur when the road condition is wet, snowy, or icy. If the ambient temperature 356 is greater than a predetermined temperature (e.g., 80 degrees Fahrenheit) while the wheel slip is occurring, it is not likely that the roads are snowy or icy as snow and ice would melt. The windshield wiper state 360 indicating that the windshield wipers are on, however, may indicate that the road condition is wet. Ambient humidity being greater than a predetermined percentage (e.g., 90 percent) may help verify that the road condition is wet. This set of inputs may help more accurately determine that the road condition is wet when considered along with the sensor feature map 344.

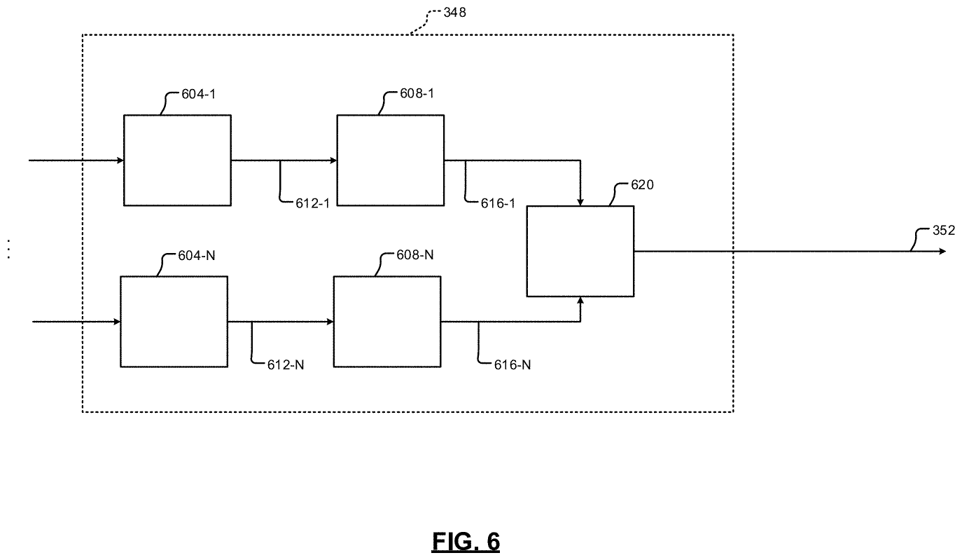

FIG. 6 is a functional block diagram of an example implementation of the information map module 348. The information map module 348 includes N categorization modules 604-1, . . . , 604-N (collectively categorization modules 604) where N is an integer greater than one. The information map module 348 also includes N feature sheet modules 608-1, . . . , 608-N (collectively feature sheet modules 608) associated with the categorization modules 604, respectively.

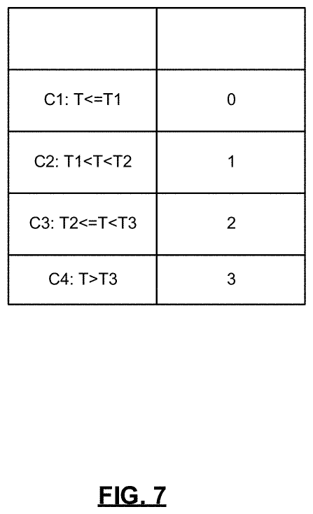

The categorization modules 604 receive N different types of information, respectively, such as 356-372 discussed above. The categorization modules 604 generate N pixel expressions 612-1, . . . , 612-N based on the N types of information, respectively, and respective mappings of values/states of the respective information to category values. FIG. 7 includes an example mapping of temperature values to category values for the ambient temperature 356. For example, the categorization module 604-1 may set the category values of the pixel expression 612-1 to 0 when the ambient temperature 356 is less than or equal to a first predetermined temperature (T1), to 1 when the ambient temperature 356 is between the first predetermined value and a second predetermined temperature (T2), to 2 when the ambient temperature 356 is greater than or equal to the second predetermined temperature but less than a third predetermined temperature (T3), and to 4 when the ambient temperature 356 is greater than or equal to the third predetermined temperature. A mapping is stored for each of the different types of information. The categorization transforms raw information into meaningful information, speeds up learning, and leads to faster convergence.

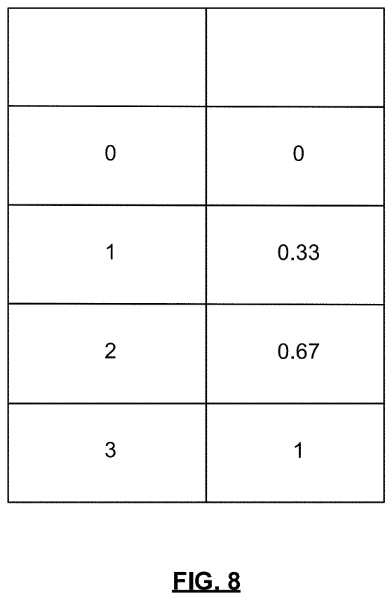

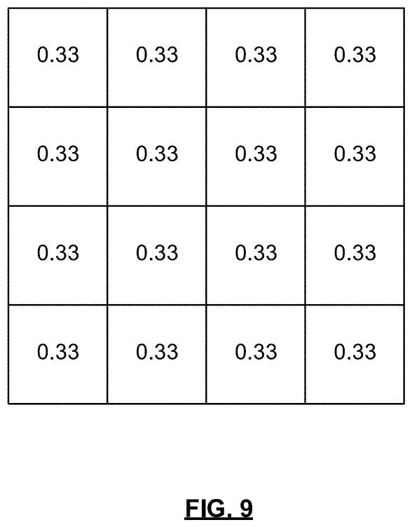

The feature sheet modules 608 generate the N feature sheets 616-1, . . . , 616-N based on the pixel expressions 612, respectively, and respective mappings of category values to pixel values. FIG. 8 includes an example mapping of category values to pixel values for the ambient temperature 356. A mapping is stored for each of the different types of information. FIG. 9 includes an example illustration of the feature sheet 616-1 generated for the ambient temperature 356. This translates the information into information that is understandable by a neural network to determine road condition. This also translates the information into mappings that are compatible with the sensor feature map 344 (e.g., the same dimensions and scale).

A fusion module 620 fuses the feature sheets 616 together to generate the information feature map 352. For example, the fusion module 620 may concatenate the feature sheets 616 to generate the information feature map 352.

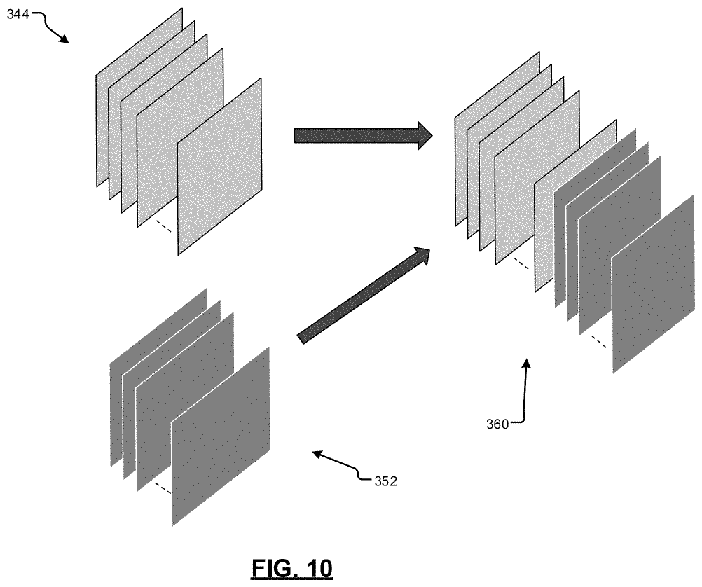

Referring back to FIG. 3, a joining module 358 joins the sensor feature map 344 with the information feature map 352 to produce a joint feature map 362. In other words, the joining module 358 generates the joint feature map 362 based on the information feature map 352 and the sensor feature map 344. For example, the joining module 358 may concatenate the sensor feature map 344 and the information feature map 352 to generate the information feature map 352. An example of the joining is illustrated in FIG. 10.

A condition module 366 determines the road condition 370 based on the joint feature map 362 thereby jointly considering the data from the external sensors/cameras 186 and the different types of information in determining the road condition 370. The condition module 366 may include, for example, a neural network including a plurality of fully connected layers configured to set the road condition 370 based on the joint feature map 362. Examples of the road condition 370 include dry, wet, snow covered, ice covered, and other suitable road conditions. In various implementations, the condition module 366 may include a state vector machine configured to set the road condition 370 based on the joint feature map 362.

One or more modules may take one or more actions based on the road condition 370 as discussed above. For example, the ECM 106 may selectively adjust torque output of the engine 102 based on the road condition 370. Additionally or alternatively, the brake control module 150 may selectively adjust braking based on the road condition 370. Additionally or alternatively, the PIM 134 may selectively adjust torque output of one or more electric motors based on the road condition 370. Additionally or alternatively, the steering control module 140 may selectively adjust steering based on the road condition 370. Additionally or alternatively, the TCM 114 may selectively adjust one or more operating parameters of the transmission 110 based on the road condition 370.

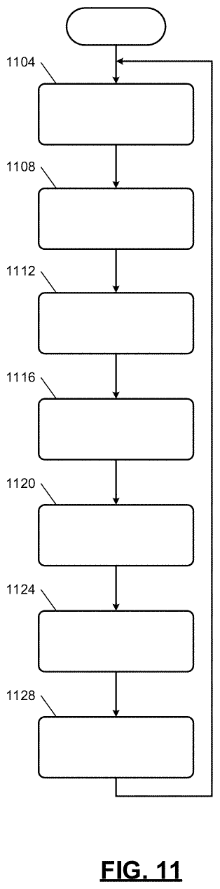

FIG. 11 is a flowchart depicting an example method of determining a condition of a road in front of a vehicle. Control begins with 1104 where the image generation module 304 generates the images 308, 316, and 324 as described above based on the image 312, the LIDAR data 320, and the radar data 328, respectively.

At 1108, the combination module 332 generates the combined image 336 by combining the images 308, 316, and 324, as discussed above. At 1112, the feature extraction module 340 extracts features from the combined image 336 to generate the sensor feature map 344, as discussed above. At 1116, the information map module 348 generates the information feature map 352 based on the inputs, such as 356-372, as discussed above. In various implementations, 1116 may be performed in parallel with 1104 with 1112.

At 1120, the joining module 358 generates the joint feature map based on the sensor feature map 344 and the information feature map 352 as discussed above. At 1124, the condition module 366 sets the road condition 370 based on the joint feature map 362. The condition module 366 selects the road condition from a group consisting of predetermined road conditions, such as dry road, wet road, snow covered road, and ice covered road. At 1128, one or more modules control one or more actuators of the vehicle based on the road condition 370, as discussed above. Control may return to 1104.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A road condition detection system of a vehicle, comprising:
a combination module configured to generate a combined image based on at least:
a first image including a road in front of the vehicle generated based on one of: (a) an image captured using a camera of the vehicle, (b) light detection and ranging (LIDAR) data regarding the road in front of the vehicle, (c) radar data regarding the road in front of the vehicle, (d) ultrasonic data regarding the road in front of the vehicle; and
a second image generated based on one of: (a) an image captured using a camera of the vehicle, (b) light detection and ranging (LIDAR) data regarding the road in front of the vehicle, (c) radar data regarding the road in front of the vehicle, (d) ultrasonic data regarding the road in front of the vehicle;
a feature extraction module configured to generate a first feature map based on the combined image;
an information map module configured to generate a second feature map based on at least one of:
an ambient temperature;
a windshield wiper state;
an antilock braking system (ABS) state;
a traction control system (TCS) state;
weather at the vehicle;
a wheel slip;
an acceleration of the vehicle;
a stability control system state; and
road condition information received from at least one of a second vehicle and infrastructure;
a joining module configured to generate a joint feature map based on the first and second feature maps; and
a condition module configured to set a road condition of the road in front of the vehicle based on the joint feature map.

2. The road condition detection system of claim 1 wherein the feature extraction module includes one of a neural network and an image processor module configured to generate the first feature map based on the combined image.

3. The road condition detection system of claim 2 wherein the neural network is a convolutional neural network.

4. The road condition detection system of claim 1 wherein the combination image is configured to generate the combined image by at least one of (a) aligning edges of the first and second images, (b) concatenating the first and second images on a single plane, and (c) superimposing the first and second images.

5. The road condition detection system of claim 1 wherein the joining module is configured to generate the joint feature map by concatenating the first and second feature maps.

6. The road condition detection system of claim 1 further comprising an image generation module configured to:
receive a third image including the road in front of the vehicle captured using the camera;
determine a region of interest (ROI) including the road in front of the vehicle in the third image; and
crop the third image to the ROI to generate the first image.

7. The road condition detection system of claim 1 further comprising an image generation module configured to:
receive the LIDAR data regarding the road in front of the vehicle from a LIDAR sensor of the vehicle;
transform the LIDAR data into a third image;
determine a region of interest (ROI) including the road in front of the vehicle in the third image; and
crop the third image to the ROI to generate the first image.

8. The road condition detection system of claim 1 further comprising an image generation module configured to:
receive the radar data regarding the road in front of the vehicle from a radar sensor of the vehicle;
transform the radar data into a third image;
determine a region of interest (ROI) including the road in front of the vehicle in the third image; and
crop the third image to the ROI to generate the first image.

9. The road condition detection system of claim 1 wherein:
the combination module is configured to generate the combined image based on: (a) the first image including a road in front of the vehicle generated based on a fourth image captured using a camera of the vehicle, (b) the second image generated based on light detection and ranging (LIDAR) data regarding the road in front of the vehicle, and (c) a third image generated based on radar data regarding the road in front of the vehicle;
the road condition detection system further includes an image generation module configured to:
receive a fourth image including the road in front of the vehicle captured using the camera;
determine a region of interest (ROI) including the road in front of the vehicle in the fourth image;
crop the fourth image to the ROI to generate the first image;
receive the LIDAR data regarding the road in front of the vehicle from a LIDAR sensor of the vehicle;
transform the LIDAR data into a fifth image;
determine a region of interest (ROI) including the road in front of the vehicle in the fifth image;
crop the fifth image to the ROI to generate the second image;
receive the radar data regarding the road in front of the vehicle from a radar sensor of the vehicle;
transform the radar data into a sixth image;
determine a region of interest (ROI) including the road in front of the vehicle in the sixth image; and
crop the sixth image to the ROI to generate the third image.

10. The road condition detection system of claim 1 wherein the condition module includes one of a neural network configured to determine the road condition based on the joint feature map and a support vector machine configured to determine the road condition based on the joint feature map.

11. The road condition detection system of claim 10 wherein the condition module includes the neural network, and the neural network is a fully connected convolutional neural network.

12. The road condition detection system of claim 1 wherein the information map module is configured to generate the second feature map based on at least two of:
the ambient temperature;
the windshield wiper state;
the ABS state;
the TCS state;
the weather at the vehicle;
the wheel slip;
the acceleration of the vehicle;
the stability control system state; and
the road condition information received from at least one of the second vehicle and infrastructure.

13. The road condition detection system of claim 1 further comprising an engine control module configured to selectively adjust torque output of an engine of the vehicle based on the road condition.

14. The road condition detection system of claim 1 further comprising a steering control module configured to selectively adjust steering of the vehicle based on the road condition.

15. The road condition detection system of claim 1 further comprising a braking control module configured to selectively adjust brakes of the vehicle based on the road condition.

16. The road condition detection system of claim 1 further comprising a transmission control module configured to selectively adjust at least one parameter of a transmission based on the road condition.

17. The road condition detection system of claim 1 further comprising an inverter module configured to selectively adjust power applied to an electric motor of the vehicle based on the road condition.

18. The road condition detection system of claim 1 further comprising a module configured to, based on the road condition, output a at least one of (a) a visual alert and (b) an audible alert.

19. A road condition detection system of a vehicle, comprising:
a combination module configured to generate a combined image based on at least two of:
a first image including a road in front of the vehicle captured using a camera of the vehicle;
a second image generated based on light detection and ranging (LIDAR) data regarding the road in front of the vehicle; and
a third image generated based on radar data regarding the road in front of the vehicle;
a feature extraction module configured to generate a first feature map based on the combined image;
an information map module configured to generate a second feature map based on at least one of:
an ambient temperature;
a windshield wiper state;
an antilock braking system (ABS) state;
a traction control system (TCS) state;
weather at the vehicle;
a wheel slip;
an acceleration of the vehicle;
a stability control system state; and
road condition information received from at least one of a second vehicle and infrastructure;
a joining module configured to generate a joint feature map based on the first and second feature maps; and
a condition module configured to set a road condition of the road in front of the vehicle based on the joint feature map.

20. A road condition detection method for a vehicle, comprising:
generating a combined image based on at least:
a first image including a road in front of the vehicle generated based on one of: (a) an image captured using a camera of the vehicle, (b) light detection and ranging (LIDAR) data regarding the road in front of the vehicle, (c) radar data regarding the road in front of the vehicle, (d) ultrasonic data regarding the road in front of the vehicle; and
a second image generated based on one of: (a) an image captured using a camera of the vehicle, (b) light detection and ranging (LIDAR) data regarding the road in front of the vehicle, (c) radar data regarding the road in front of the vehicle, (d) ultrasonic data regarding the road in front of the vehicle;
generating a first feature map based on the combined image;
generating a second feature map based on at least one of:
an ambient temperature;
a windshield wiper state;
an antilock braking system (ABS) state;
a traction control system (TCS) state;
weather at the vehicle;
a wheel slip;
an acceleration of the vehicle;
a stability control system state; and
road condition information received from at least one of a second vehicle and infrastructure;
generating a joint feature map based on the first and second feature maps; and
setting a road condition of the road in front of the vehicle based on the joint feature map.
